(19) United States
(12) Patent Application Publication
(10) Pub. No.: US 2019/0076921 A1
(43) Pub. Date: Mar. 14, 2019

(54) COATED SILVER PARTICLE AND MANUFACTURING METHOD THEREFOR, CONDUCTIVE COMPOSITION, AND CONDUCTOR

(71) Applicant: Kyoritsu Chemical & Co., Ltd., Tokyo (JP)

(72) Inventors: Yu OYAMA, Kisarazu-shi, Chiba-ken (JP); Yasumasa KAWANA, Kisarazu-shi, Chiba-Ken (JP); Kunihiro FUKUMOTO, Kisarazu-shi, Chiba-Ken (JP)

(21) Appl. No.: 16/084,265

(22) PCT Filed: Mar. 22, 2017
(86) PCT No.: PCT/JP2017/011388

§ 371 Date: Sep. 12, 2018

(30) Foreign Application Priority Data
Mar. 28, 2016 (JP) 2016-064296

(51) Int. Cl. B22F 1/00; B22F 9/30; H01B 1/22

(52) U.S. Cl. CPC B22F 1/0062; B22F 1/0018; B22F 2304/054; H01B 1/22; B22F 2301/255; B22F 9/30

(57) ABSTRACT

A coated silver particle (20) according to the present invention contains a silver core particle (21), and a plurality of aliphatic carboxylic acid molecules (22) absorbed to a surface of the silver core particle (21) at a density of 2.5 to 5.2 molecules per square nanometer (nm²). A carbon number of an aliphatic group of the aliphatic carboxylic acid molecule (22) is preferably 5 to 26. When an arithmetical average value and a standard deviation of primary particle diameters are represented by D_{SEM} and SD, respectively, D_{SEM} is preferably 0.02 to 5.0 μm and a particle diameter variation rate defined by a general formula SD/D_{SEM} is preferably 0.01 to 0.5.

### TECHNICAL FIELD

The present invention relates to coated silver particles and their manufacturing method, a conductive composition containing coated silver particles, and a conductor manufactured by using a conductive composition.

### BACKGROUND ART

In recent years, as a method for forming a pattern of a conductor such as wiring lines and a conductor layer, a printing method in which a pasty conductive composition containing a metal powder and a sintering agent is directly printed into a desired pattern has been attracting attention as an alternative to photolithography which requires a large number of processes. Examples of the printing method include an ink-jet printing method, a screen printing method, a flexographic printing method, a dispensing printing method, etc.

Regarding the sintering agent contained in the conductive composition, it is preferred to use metal particles having a particle diameter smaller than that of a metal powder. Examples of the metal particles for the sintering agent include gold particles, silver particles, copper particles, etc.

Compared to gold and silver, which are noble metals, copper tends to be oxidized more easily and an oxide film tends to be easily formed on its surface.

The inventors of the present application filed an application for an invention related to coated copper particles having an excellent oxidation resistance in the past.

The inventors of the present application have disclosed, in Patent Literature 1, coated copper particles containing copper core particles and a coating layer containing long-chain aliphatic amine as a main component, and a manufacturing method therefor (claim 1, claim 4, etc.).

Further, the inventors of the present application have disclosed, in Patent Literature 2, coated copper particles whose surfaces are coated with an aliphatic carboxylic acid and a manufacturing method therefor (claim 1).

Since the surfaces of coated copper particles disclosed in Patent Literature 1 and 2 are coated with organic substances, they each have excellent oxidation resistance, excellent grain-size stability, and excellent particle dispersing property in media. Further, since the organic substance is simply adsorbed (physical adsorption, ion adsorption, etc.) to the copper core particles, it can be easily desorbed from the copper core particles in the sintering process. Therefore, coated copper particles disclosed in Patent Literature 1 and 2 also have excellent sintering properties.

### CITATION LIST

### Patent Literature

Patent Literature 1: Japanese Unexamined Patent Application Publication No. 2014-001443

Patent Literature 2: Japanese Unexamined Patent Application Publication No. 2015-227476

### SUMMARY OF INVENTION

### Technical Problem

Patent Literature 1 and 2 disclose inventions related to copper particles, but do not disclose their application to silver particles. Although silver particles have an excellent oxidation resistance, they have low resistance to corrosion by a sulfide gas and the like.

The present invention has been made in view of the above-described problem and an object thereof is to provide coated silver particles having an excellent corrosion resistance, excellent grain-size stability, an excellent particle dispersing property in a medium, and an excellent sintering property.

### Solution to Problem

A coated silver particle according to the present invention contains a silver core particle, and a plurality of aliphatic carboxylic acid molecules disposed on a surface of the silver core particle at a density of 2.5 to 5.2 molecules per square nanometer (nm²).

In the coated silver particle according to the present invention, a carbon number of an aliphatic group of the aliphatic carboxylic acid molecule is preferably 5 to 26.

When an arithmetical average value and a standard deviation of primary particle diameters are represented by D_{SEM} and SD, respectively, D_{SEM} is preferably 0.02 to 5.0 μm and a particle-diameter variation rate defined by a general formula SD/D_{SEM} is preferably 0.01 to 0.5, the primary particle diameters being obtained by observing 20 arbitrarily-selected particles by a scanning electron microscope.

A manufacturing method for coated silver particles according to the present invention includes a step (A) of thermally decomposing an aliphatic carboxylic acid silver complex in a medium.

In the manufacturing method for coated silver particles according to the present invention,

the step (A) preferably includes:

a step (A1) of preparing a reaction solution containing silver carboxylate, an aliphatic carboxylic acid, and a medium; and

a step (A2) of thermally decomposing a complex compound formed in the reaction solution and thereby generating metallic silver.

The reaction solution preferably further contains a complexing agent.

The complexing agent is preferably an amino alcohol.

A thermal decomposition temperature of the silver carboxylate is preferably 100° C. or higher.

A conductive composition according to the present invention contains the above-described coated silver particle according to the present invention and a medium.

A conductor according to the present invention is a heat-treated product of the above-described conductive composition according to the present invention.

Examples of the conductor according to the present invention include wiring lines and a conductor layer.

### “Particle Diameter”

In this specification, a “particle diameter” means a primary particle diameter, unless otherwise specified.

### “Average Primary Particle Diameter and Particle-Diameter Variation Rate of Particles (Silver Core Particles or Coated Silver Particles)”

In this specification, an “average primary particle diameter of particles (silver core particles or coated silver particles)” means an arithmetical average value (D_{SEM}) of primary particle diameters obtained by observing 20 arbitrarily-selected particles (silver core particles or coated silver particles) by a scanning electron microscope (SEM), unless otherwise specified.

Note that it can be considered that an average primary particle diameter of silver core particles is substantially the same as an average primary particle diameter of coated silver particles containing the silver core particles.

The “particle-diameter variation rate” is a value obtained by dividing a standard deviation (SD) of primary particle diameters of 20 arbitrarily-selected particles (silver core particles or coated silver particles) obtained by a SEM observation by an average primary particle diameter (D_{SEM}) thereof, i.e., (Standard deviation (SD))/(Average primary particle diameter (D_{SEM}))“.

### “Amount of Organic Component in Coated Silver Particle”

In this specification, “an amount of an organic component(s) in coated silver particles” is measured by a thermogravimetric/differential thermal (TG-DTA) analysis, unless otherwise specified.

The measurement conditions are as follows.

Temperature rising rate: 10° C./min,
Measurement temperature range: 25 to 500° C., and
Measurement atmosphere: Nitrogen (100 ml/min).

In the above-described TG-DTA analysis, a heating loss is obtained as an amount of an organic component(s).

### “Coating Density of Aliphatic Carboxylic Acid Molecule”

In this specification, “a coating density of aliphatic carboxylic acid molecules” on surfaces of silver core particles is calculated by the following method, unless otherwise stated.

In accordance with a method disclosed in Japanese Unexamined Patent Application Publication No. 2012-88242, an organic component(s) adhering to surfaces of coated silver particles is extracted by using liquid chromatography (LC) and the extracted component(s) is analyzed.

As a measuring device, “ACQUITY UPLC H-Class System” manufactured by Waters Corporation is used. The measurement conditions are as follows.

### Column: ACQUITY UPLC (R) BEH C18 1.7 μm 2.1×50 mm,

Measurement temperature: 50° C.,
Measurement medium: water/acetonitrile, and
Flow rate: 0.8 mL/min.

A sample for LC measurement is prepared as follows.

In a sample bottle, 1 g of coated silver particles and 9 mL of acetonitrile are put. To this mixture, 1 mL of an aqueous solution of a 0.36 mass % hydrochloric acid is added. Ultrasonic waves are applied to the contents for 30 minutes, and the contents are stirred and mixed. Next, after leaving an obtained slurry liquid undisturbed and thereby separating the slurry liquid into a solid component and a liquid component, a supernatant liquid is collected. This supernatant liquid is filtered by a filter having a diameter of 0.2 μm and the obtained substance is used as a sample for LC measurement.

By the above-described method, a thermogravimetric/differential thermal analysis (TG-DTA) is performed and an amount of an organic component(s) contained in the coated silver particles is measured.

A molecular weight of an aliphatic carboxylic acid contained in the coated silver particles is calculated based on the result of the LC analysis and the result of the TG-DTA analysis.

By the above-described method, an average primary particle diameter of silver cores particles is measured.

The number of the aliphatic carboxylic acid molecules contained in 1 g of coated silver particles is expressed by the below-shown Formula (a).

[Number of aliphatic carboxylic acid molecules]=Macid/(Mw/NA) (a)

In the formula, Macid is a weight (g) of an aliphatic carboxylic acid contained in 1 g of coated silver particles; Mw is a molecular weight (g/mol) of an aliphatic carboxylic acid molecule; and NA is Avogadro's constant.

Assuming that the shape of silver core particles is spherical, an amount MAg (g) of the silver core particles is obtained by subtracting the amount of the organic component from the mass of the coated silver particles.

By using the amount MAg (g) of the silver core particles, the number of silver core particles in 1 g of coated silver particles is expressed by the below-shown Formula (b).

[Number of silver core particles in 1 g of coated silver particles]=MAg/[(4πr³/3)×d×10⁻²¹] (b)

In the formula, MAg is an amount (g) of silver core particles contained in 1 g of coated silver particles; r is a radius (nm) of a primary particle diameter of the silver core particle calculated by SEM image observation; and d is a density of silver (d=10.49 g/cm³).

From Formula (b), a surface area of silver core particles contained in 1 g of coated silver particles is expressed by the below-shown Formula (c).

[Surface area (nm²) of silver core particles contained in 1 g of coated silver particles]=[Number of silver core particles]×4πr² (c)

By using Formulas (a) and (c), a coating density (molecules/nm²) of aliphatic carboxylic acid molecules on silver core particles is calculated by the below-shown Formula (d).

[Coating density (molecules/nm²)]=[Number of aliphatic carboxylic acid molecules]/[Surface area of silver core particles] (d)

### Advantageous Effects of Invention

According to the present invention, it is possible to provide coated silver particles having an excellent corrosion resistance, excellent grain-size stability, an excellent particle dispersing property in a medium, and an excellent sintering property.

### BRIEF DESCRIPTION OF DRAWINGS

FIG. 1 shows a schematic diagram of a conductive composition according to an embodiment of the present invention;

FIG. 2 shows a schematic diagram of a coated silver particle according to an embodiment of the present invention;

FIG. 3A shows a step in a manufacturing method for a laminated product in Example 3;

FIG. 3B shows a step in the manufacturing method for the laminated product in Example 3;

FIG. 4 is a TG curve of coated silver particles (AgP1) obtained in Example 1-1;

FIG. 5A is an SEM photograph of coated silver particles (AgP1) obtained in Example 1-1; and

FIG. 5B is an SEM photograph of coated silver particles (AgP2) obtained in Example 1-2.

### DESCRIPTION OF EMBODIMENTS

The present invention is described hereinafter in detail.

### “Coated Silver Particle”

A coated silver particle according to the present invention contains a silver core particle, and a plurality of aliphatic carboxylic acid molecules disposed on a surface of the silver core particle at a density of 2.5 to 5.2 molecules per square nanometer (nm²).

Coated silver particles according to the present invention can be used for the same purposes for which silver particles are used, and can be used alone as metal particles or in combination with other metal particles.

Coated silver particles according to the present invention can be used, for example, in combination with a metal powder having a particle diameter larger than that of the above-described silver core particles. In this case, the coated silver particles according to the present invention can be used as a sintering agent for the metal powder.

In the case where coated silver particles according to the present invention are used as a sintering agent for a metal powder having a particle diameter larger than that of the above-described silver core particles, a mass ratio between the coated silver particles according to the present invention and the metal powder ((Coated silver particles according to the present invention):(Metal powder)) is not limited to any particular ratio, and is preferably 20:80 to 80:20, more preferably 30:70 to 70:30, and particularly preferably 40:60 to 60:40.

### “Conductive Composition”

A conductive composition according to the present invention contains the above-described coated silver particles and a medium.

In an aspect, a conductive composition according to the present invention contains a metal powder having a particle diameter larger than that of the coated silver particles.

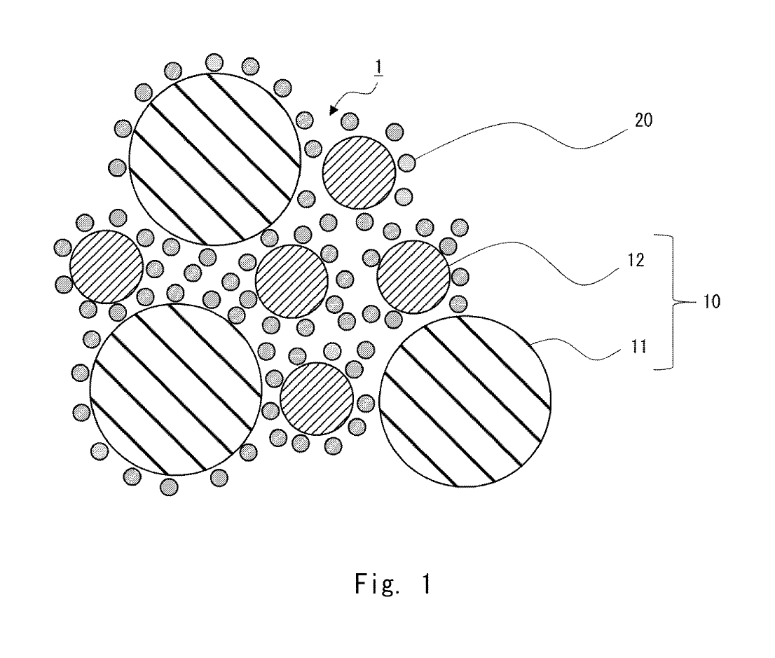

FIG. 1 shows a schematic diagram of a conductive composition according to an embodiment of the present invention.

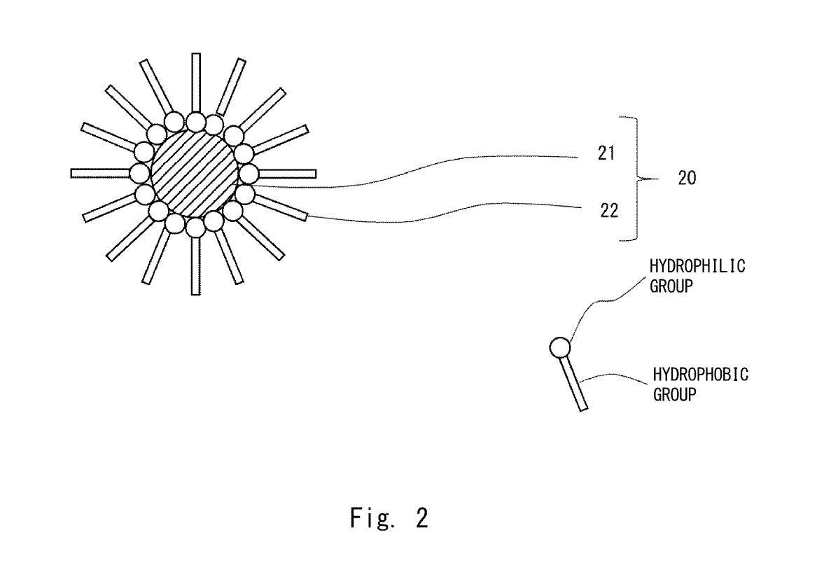

FIG. 2 shows a schematic diagram of a coated silver particle according to an embodiment of the present invention.

As shown in a lower-right part in FIG. 2, a “hydrophilic group” and a hydrophobic group are schematically shown as a circle and a rod, respectively.

As shown in FIG. 1, a conductive composition 1 according to this embodiment contains a metal powder 10, coated silver particles 20, and a medium (not shown).

In the figure, the shape, the particle diameter, the distribution, and the like of each particle of the metal powder 10 and each particle of the coated silver particles 20 are schematically drawn.

A metal powder made of a publicly-known conductive composition can be used as the metal powder 10.

Examples of the metal powder 10 include a copper powder, a silver powder, etc.

A plurality of types of metal powders having different average primary particle diameters are preferably used as the metal powder 10. By using a plurality of types of metal powders having different average primary particle diameters, grains of a metal powder having a relatively small average primary particle diameter enter gaps among grains of a metal powder having a relatively large average primary particle diameter. Therefore, it is possible to improve the packing density of the metal powders.

FIG. 1 shows a case where the metal powder 10 includes a first metal powder 11 having a relatively large average primary particle diameter and a second metal powder 12 having a relatively small average primary particle diameter.

The average primary particle diameter of the first metal powder 11 having the relatively large average primary particle diameter is not limited to any particular value, and is preferably 1 to 100 μm and more preferably 1 to 50 μm.

The average primary particle diameter of the second metal powder 12 having the relatively small average primary particle diameter is not limited to any particular value, and is preferably 0.2 to 10 μm and more preferably 0.2 to 5 μm.

The conductive composition 1 according to this embodiment contains coated silver particles 20 that act as a sintering agent.

As shown in FIG. 2, the coated silver particles 20 contain silver core particles 21 having a particle diameter smaller than that of the metal powder 10 and a plurality of aliphatic carboxylic acid molecules 22 covering surfaces of the silver core particles 21.

In this embodiment, the plurality of aliphatic carboxylic acid molecules 22 are adsorbed on the surfaces of the silver core particles 21. The form of the adsorption is not limited to any particular form. Examples of the absorption include physical adsorption, ion adsorption, etc.

In an aspect, the plurality of aliphatic carboxylic acid molecules 22 are physically adsorbed on the surfaces of the silver core particles 21 in such a manner that their carboxyl groups, which are hydrophilic groups, are positioned on the side of the silver core particles 21, so that a monomolecular film like an LB (Langmuir-Blodgett) film can be formed.

For example, when the aliphatic carboxylic acid, which is the coating material, volatilizes at or below its boiling point in TG-DTA measurement for the coated silver particles, it is presumed that the form of the coating is adsorption such as physical adsorption.

In the coated silver particles 20, i.e., the silver core particles 21 coated with a plurality of aliphatic carboxylic acid molecules 22, aliphatic groups (hydrophobic groups) of the aliphatic carboxylic acid molecules 22 are present on the outermost surfaces of the coated silver particles 20.

In general, although silver particles have an excellent oxidation resistance, they have low resistance to corrosion by a sulfide gas or the like.

The coated silver particles 20 whose surfaces are coated with the aliphatic carboxylic acid molecules 22 have an excellent oxidation resistance and an excellent corrosion resistance to a sulfur gas and the like.

Hydrophobic groups of the coated silver particles 20 interact with each other, so that the coagulation of the coated silver particles 20 is suppressed. Therefore, after being manufactured, the coated silver particles 20 having the above-described structure have excellent grain-size stability and an excellent particle dispersing property in a medium.

Since the aliphatic carboxylic acid molecules 22 are simply adsorbed (physical adsorption, ion adsorption, etc.) to the silver core particles 21, they can be easily desorbed from the silver core particles 21 in the sintering process. Therefore, the coated silver particles 20 also have an excellent sintering property.

The conductive composition 1 according to this embodiment, containing the coated silver particles 20 having the above-described structure has an excellent particle dispersing property of the metal powder 10 and the coated silver particles 20, which act as a sintering agent, and an excellent sintering property.

As described above, according to this embodiment, it is possible to provide coated silver particles 20 having an excellent oxidation resistance, an excellent corrosion resistance, excellent grain-size stability, an excellent particle dispersing property in a medium, and an excellent sintering property.

Further, according to this embodiment, it is possible to provide a conductive composition 1 having an excellent particle dispersing property and an excellent sintering property.

Each of the components of the conductive composition, except for the metal powder, is described hereinafter in detail.

### (Silver Core Particle)

An average primary particle diameter of silver core particles is not limited to any particular value, and may be any diameter within a range in which they are suitable as a sintering agent.

The average primary particle diameter of silver core particles is preferably 0.02 μm (20 nm) to 5.0 μm, more preferably 0.02 μm (20 nm) to 1.0 μm, even more preferably 0.02 μm (20 nm) to 0.5 μm, and particularly preferably 0.02 μm (20 nm) to 0.2 μm.

When the average primary particle diameter is smaller than 0.02 μm (20 nm), it is very difficult to produce particles. Further, when the average primary particle diameter exceeds 5.0 μm, the packing effect could be insufficient.

A purity of silver core particles is not limited to any particular value, and is preferably high because a conductor having a high conductivity can be obtained. The purity of silver core particles is preferably 95 mass % or higher and more preferably 97 mass % or higher.

### (Aliphatic Carboxylic Acid Molecule)

The type of aliphatic carboxylic acid molecules covering surfaces of silver core particles is not limited to any particular type.

The number of carboxy groups contained in the aliphatic carboxylic acid molecule is not limited to any particular number, and is preferably 1 to 2 and more preferably 1.

The aliphatic carboxylic acid molecules may be saturated aliphatic carboxylic acid molecules or unsaturated aliphatic carboxylic acid molecules. In the case where the aliphatic carboxylic acid molecules are unsaturated aliphatic carboxylic acid molecules, the number of unsaturated bonds contained in the unsaturated aliphatic group is preferably 1 to 3 and more preferably 1 to 2.

The aliphatic group contained in the aliphatic carboxylic acid molecule may be a linear-chain type or a branched-chain type, and is preferably the linear-chain type.

A carbon number of the aliphatic group of the aliphatic carboxylic acid molecule is preferably 5 or larger because when the carbon number is 5 or larger, coated silver particles having uniform particle diameters can be efficiently produced and hence an effect of improving a corrosion resistance and a particle dispersing property of the coated silver particles is effectively developed.

In the following description, an aliphatic carboxylic acid containing an aliphatic group having a carbon number of 5 or larger is also referred to as a “long-chain carboxylic acid”.

When the carbon number of the aliphatic group is 5 or larger, the particle-diameter variation rate of the coated silver particles tends to be reduced. In general, the length of a carbon chain is highly correlated with the magnitude of the Van der Waals force, which influences the associative force. A carboxylic acid having a long carbon chain has a strong associative force and can contribute to phase stabilization similar to Water-in-oil Emulsion, which is a micro reaction field, in a later-described manufacturing method. It is considered that, because of this feature, it is possible to efficiently produce coated silver particles having uniform particle diameters.

The carbon number of the aliphatic group is preferably 5 to 26, more preferably 5 to 20, further preferably 5 to 17, particularly preferably 7 to 17, and most preferably 9 to 17. This is because when the carbon number is in the aforementioned ranges, coated silver particles having uniform particle diameters can be efficiently produced; an effect of improving a corrosion resistance and a particle dispersing property of the coated silver particles is effectively developed; and a thermal decomposing property in the sintering process is improved.

A boiling point of aliphatic carboxylic acid molecules is preferably higher than a thermal decomposition temperature of an aliphatic carboxylic acid silver complex in a later-described manufacturing method.

Specifically, the boiling point of aliphatic carboxylic acid molecules is preferably 100° C. or higher and more preferably 120° C. or higher. The boiling point of aliphatic carboxylic acid molecules is preferably 400° C. or lower because when the boiling point is 400° C. or lower, the thermal decomposing property of the aliphatic carboxylic acid molecules in the sintering process is improved.

Examples of the aliphatic carboxylic acid molecules include:

unsaturated aliphatic carboxylic acid molecules such as an oleic acid and a linoleic acid; and

saturated aliphatic carboxylic acid molecules such as a stearic acid, a heptadecanoic acid, a lauric acid, and an octanoic acid.

One type or two or more types of aliphatic carboxylic acid molecules can be used.

A coating density of a plurality of aliphatic carboxylic acid molecules on surfaces of silver core particles is 2.5 to 5.2 molecules/nm², preferably 3.0 to 5.2 molecules/nm², and more preferably 3.5 to 5.2 molecules/nm². This is because when the covering density is in the aforementioned ranges, an effect of improving a corrosion resistance and a particle dispersing property of the coated silver particles is effectively developed.

### (Medium)

As a medium, a publicly-known medium used for an ordinary conductive composition can be used.

Examples of the medium include hydrocarbon solvents, higher alcohol solvents, Cellosolve, Cellosolve acetate solvents, etc.

One type or two or more types of media can be used.

A solid-content concentration of the conductive composition is not limited to any particular value and is selected according to the printing method. For example, the solid-content concentration is 10 to 99 mass % and preferably 40 to 95 mass %.

### (Optional Component)

A conductive composition according to the present invention may contain one type or two or more types of optional components as required.

### <Dispersant>

If necessary, a publicly-known polymer dispersant such as polyester dispersants and polyacrylic acid dispersants can be used as a dispersant.

### <Thickener>

If necessary, a publicly-known polymeric thickener such as polymethacrylic acid thickeners can be used as a thickener.

### <Coupling Agent>

If necessary, a coupling agent such as a silane coupling agent and a titanate coupling agent can be used.

### [Manufacturing Method for Coated Silver Particle]

A manufacturing method for coated silver particles according to the present invention includes a step (A) of thermally decomposing an aliphatic carboxylic acid silver complex in a medium.

By thermally decomposing an aliphatic carboxylic acid silver complex, silver core particles and an aliphatic carboxylic acid are generated. Further, a plurality of aliphatic carboxylic acid molecules are adsorbed on a surface of one generated silver core particle (physical adsorption, ion adsorption, etc.). As a result, a coated silver particle (20) in which a plurality of aliphatic carboxylic acid molecules are adsorbed (physical adsorption, ion adsorption, etc.) on a surface of a silver core particle at a predetermined coating density is formed.

In an aspect,

the step (A) can include:

a step (A1) of preparing a reaction solution containing silver carboxylate (carboxylic acid silver), an aliphatic carboxylic acid, and a medium; and

a step (A2) of thermally decomposing a complex compound (an aliphatic carboxylic acid silver complex) formed in the reaction solution and thereby generating metallic silver.

The reaction solution may further contain a complexing agent as required.

In general, when silver carboxylate is converted into a complex, its thermal decomposition temperature tends to decrease. The present inventors have found that the thermal decomposition temperature of the aliphatic carboxylic acid silver complex affects the particle diameters of the generated coated silver particles. When the thermal decomposition temperature of the aliphatic carboxylic acid silver complex is too low, the thermal decomposition reaction is accelerated by reaction heat generated in the complexing reaction. As a result, the control of the grain size could become difficult.

The thermal decomposition temperature of the silver carboxylate used as the ingredient is preferably 100° C. or higher. This is because when the thermal decomposition temperature is 100° C. or higher, coated silver particles having particle diameters in a range in which they are suitable as a sintering agent can be stably obtained.

For example, the thermal decomposition temperature of silver formate is about 110° C. and the thermal decomposition temperature of silver oxalate is about 210° C.

Each of the components of the reaction solution is described hereinafter.

### <Silver Carboxylate>

The carboxylic acid silver used as the ingredient is not limited to any particular compound, and is preferably silver formate, silver oxalate, silver carbonate, and silver citrate, or the like in view of the reducing property of silver ions, the thermal decomposition temperature, the availability of the ingredient, the easiness of production of the ingredient, and the like. Among them, silver oxalate or the like is preferred because of its high thermal decomposition temperature.

Silver oxalate is composed of 2 moles of monovalent silver ions and 1 mole of oxalate ions.

For the silver oxalate, a commercially available product may be used or it may be produced by using a publicly-known method.

An oxalic acid has a reducing property. Therefore, when silver oxalate is thermally decomposed, monovalent silver ions are reduced and reduced silver particles are produced.

The content of silver oxalate in the reaction solution is not limited to any particular amount, and is preferably 0.5 to 2.5 mol/L, more preferably 1.0 to 2.5 mol/L, and particularly preferably 1.5 to 2.0 mol/L in view of the production efficiency and the like.

### <Aliphatic Carboxylic Acid>

The aliphatic carboxylic acid used as the ingredient is not limited to any particular compound, and is selected according to the structure of aliphatic carboxylic acid molecules contained in desired coated silver particles.

The carbon number of the aliphatic carboxylic acid used as the ingredient is equal to the carbon number of the aliphatic group of the aliphatic carboxylic acid molecule contained in the desired coated silver particles.

The carbon number of the aliphatic carboxylic acid used as the ingredient is preferably 5 or larger because when the carbon number is 5 or larger, coated silver particles having uniform particle diameters can be efficiently produced and hence an effect of improving a corrosion resistance and a particle dispersing property of the coated silver particles is effectively developed.

The carbon number of the aliphatic carboxylic acid used as the ingredient is preferably 5 to 26, more preferably 5 to 20, further preferably 5 to 17, particularly preferably 7 to 17, and most preferably 9 to 17. This is because when the carbon number is in the aforementioned ranges, coated silver particles having uniform particle diameters can be efficiently produced; an effect of improving a corrosion resistance and a particle dispersing property of the coated silver particles is effectively developed; and a thermal decomposing property in the sintering process is improved.

The boiling point of the aliphatic carboxylic acid used as the ingredient is preferably higher than the heating temperature of the reaction solution. Specifically, the boiling point of aliphatic carboxylic acid molecules is preferably 100° C. or higher and more preferably 120° C. or higher.

The boiling point of aliphatic carboxylic acid molecules used as the ingredient is preferably 400° C. or lower because when the boiling point is 400° C. or lower, the thermal decomposing property of the aliphatic carboxylic acid molecules contained in the coated silver particles in the sintering process is improved.

Examples of the aliphatic carboxylic acid used as the ingredient include:

an unsaturated aliphatic carboxylic acid such as an oleic acid and a linoleic acid; and

a saturated aliphatic carboxylic acid such as a stearic acid, a heptadecanoic acid, a lauric acid, and an octanoic acid.

One type or two or more types of aliphatic carboxylic acids can be used as the ingredient.

The content of the aliphatic carboxylic acid in the reaction solution is not limited to any particular amount, and is preferably 2.5 to 25 mol % and more preferably 5.0 to 15 mol %.

When the content of the aliphatic carboxylic acid in the reaction solution is 2.5 mol % or larger, a satisfactory reaction rate is achieved. Therefore, the productivity tends to be improved and the particle-diameter variation rate of the coated silver particles tends to be reduced.

When the content of the aliphatic carboxylic acid in the reaction solution is 25 mol % or smaller, an increase in the viscosity of the reaction system is suppressed and an excellent stirring property is obtained.

### <Complexing Agent>

The complexing agent is not limited to any particular compound, and is preferably an amino alcohol or the like.

By the presence of a complexing agent such as an amino alcohol in the reaction solution, a complex compound is effectively formed from the carboxylic acid silver.

The complex compound is easily dissolved in the medium.

An amino alcohol is an alcohol compound containing at least one amino group.

The number of amino groups is not limited to any particular number, and is preferably one. That is, the amino alcohol is preferably a monoamino monoalcohol. Among them, a monoamino monoalcohol in which an amino group is not replaced and a monodentate monoamino monoalcohol are preferred.

The boiling point of the amino alcohol is not limited to any particular temperature, and is preferably higher than the heating temperature of the reaction solution. Specifically, the boiling point of the amino alcohol is preferably 120° C. or higher and more preferably 130° C. or higher. The boiling point of the amino alcohol is preferably 400° C. or lower and more preferably 300° C. or lower.

The SP value of the amino alcohol is preferably 11.0 or higher, more preferably 12.0 or higher, and particularly preferably 13.0 or higher because when the SP value is in the aforementioned ranges, the solubility to the medium and the boiling point become suitable for the reaction. The SP value of the amino alcohol is preferably 18.0 or lower and more preferably 17.0 or lower.

In this specification, the term “SP value” is a solubility parameter defined by Hildebrand and is the square root of intermolecular binding energy E1 in 1 mL of a sample at 25° C., unless otherwise specified.

In this specification, the “SP value” is obtained in accordance with a method disclosed in the below-shown web site, unless otherwise specified.

### Website of Japan Petroleum Institute

(http://sekiyu-gakkai.orjp/jp/dictionary/petdicsolvent.html#solubility2)

Specifically, the SP value is calculated as follows.

The intermolecular binding energy E1 is a value obtained by subtracting gas energy from latent heat of vaporization Hb.

The latent heat of vaporization Hb is obtained from the boiling point Tb of the sample based on the below-shown Formula.

Hb=21*(273+Tb)

Molar latent heat of vaporization H25 at 25° C. is obtained from the latent heat of vaporization Hb based on the below-shown Formula.

H25=Hb×[1+0.175×(Tb−25)/100]

Intermolecular bonding energy E of the total amount of the sample is obtained from the molar latent heat of vaporization H25 based on the below-shown Formula.

E=H25−596

Intermolecular binding energy E1 in 1 mL of the sample is obtained from the intermolecular bonding energy E of the total amount of the sample based on the below-shown Formula.

E1=E×D/Mw

(In the above-shown Formula, D is a density of the sample and Mw is a molecular weight of the sample.)

The SP value is calculated from the intermolecular bonding energy E1 in 1 mL of the sample based on the below-shown Formula.

SP=(E1)^{1/2}

Note that for a sample containing an OH group, it is necessary to make a correction of +1 for each OH group (see Mitsubishi Oil Technical Material, No. 42, p 3, p 11 (1989)).

Examples of the amino alcohol include

2-aminoethanol (Boiling point: 170° C., SP value: 14.54),

3-amino-1-propanol (Boiling point: 187° C., SP value: 13.45),

5-amino-1-pentanol (Boiling point: 245° C., SP value: 12.78),

DL-1-amino-2-propanol (Boiling point: 160° C., SP value: 12.74),

N-methyldiethanolamine (Boiling point: 247° C., SP value: 13.26), etc.

One type or two or more types of these alcohols can be used.

The content of amino alcohol in the reaction solution is not limited to any particular amount, and is preferably 1.5 to 4.0 times and more preferably 1.5 to 3.0 times of the amount of silver ions in the reaction solution in terms of moles.

When the content of the amino alcohol is 1.5 times that of the silver ions or larger in terms of moles, the solubility of the carboxylic acid silver is improved and hence the reaction time can be reduced.

When the content of the amino alcohol is 4.0 times that of the silver ions or smaller in terms of moles, it is possible to suppress adhesion of unnecessary amino alcohols to the generated coated silver particles.

### <Medium>

One type or two or more types of media can be used.

As the medium, one type or two or more types of organic media can be selected from organic media that are commonly used for chemical reactions.

As the medium, it is preferable to use a medium that does not hinder the reduction reaction of silver ions by the carboxylic acid and has a ΔSP value of 4.2 or higher. Here, the ΔSP value is a difference between the SP value of the amino alcohol and that of the medium.

When the ΔSP value is 4.2 or higher, the width of the grain-size distribution of the generated coated silver particles becomes narrower, and there is a tendency that coated silver particles having uniform particle diameters can be obtained.

In view of the forming property of the reaction field and the quality of the coated silver particles, the ΔSP value is preferably 4.5 or higher, more preferably 5.0 or higher, and particularly preferably 7.0 or higher.

The ΔSP value is preferably 11.0 or lower and more preferably 10.0 or lower.

The SP value of the medium is preferably lower than that of the amino alcohol.

When two or more types of media are used, the SP value of the media is defined based on an average SP value of the media in which the SP value and the mole fraction of each of the media are taken into account.

For example, when two types of media, media 1 and 2, are used, the average SP value is calculated by the below-shown Formula.

δ3=(V1×δ1+V2×δ2)/(V1+V2)

(In the above-shown Formula, each symbol has the following meaning.
δ3: Average SP value of the mixed medium,
δ1: SP value of the medium 1,
V1: Molar volume of the medium 1,
δ2: SP value of the medium 2, and
V2: Molar volume of the medium 2.)

The medium preferably contains at least a medium that is incompatible with the amino alcohol (hereinafter, called a “primary medium”).

As the medium, it is preferable to use a medium incompatible with the amino alcohol (a primary medium) and a medium compatible with the amino alcohol (hereinafter called an “auxiliary medium”).

A preferred aspect of the primary medium is described hereinafter.

The boiling point of the primary medium is preferably higher than the heating temperature of the reaction solution. Specifically, the boiling point of the primary medium is preferably 120° C. or higher and more preferably 130° C. or higher.

The boiling point of the primary medium is preferably 400° C. or lower and more preferably 300° C. or lower.

As the primary medium, a medium capable of forming an azeotrope with water is preferred. When the primary medium can form an azeotrope with water, water that is generated in the reaction system can be easily removed in the heating step of the reaction solution.

Examples of the primary medium include ethylcyclohexane (Boiling point: 132° C., SP value: 8.18), a C9 alkyl cyclohexane mixture (e.g., “SWACLEAN 150” manufactured by Godo Co., Ltd. (Boiling point: 149° C., SP value: 7.99), n-octane (Boiling point: 125° C., SP value: 7.54), etc.).

One type or two or more types of primary media can be used.

A preferred aspect of the auxiliary medium, which may be used as required, is described hereinafter.

A preferred boiling point of the auxiliary medium is the same as that of the primary medium.

The SP value of the auxiliary medium is preferably higher than that of the primary medium and preferably high enough so that the auxiliary medium becomes compatible with the amino alcohol.

Examples of the auxiliary medium include ethylene glycol (EO) glycol ethers, propylene glycol (PO) glycol ethers, and dialkyl glycol ethers, etc.

Examples of the EO glycol ethers include methyl diglycol, isopropyl glycol, butyl glycol, etc.

Examples of the PO glycol ethers include methyl propylene diglycol, methyl propylene triglycol, propyl propylene glycol, butyl propylene glycol, etc.

Examples of the dialkyl glycol ethers include dimethyl diglycol etc.

Note that these auxiliary media are all available from Nippon Nyukazai Co., Ltd. or the like.

One type or two or more types of auxiliary media can be used.

The amount of the medium in the reaction solution is preferably adjusted so that the concentration of silver ions becomes 0.5 to 2.5 mol/L, and more preferably adjusted so that the concentration of silver ions becomes 1.0 to 2.0 mol/L.

When the concentration of silver ions in the reaction solution is 1.0 mol/L or higher, the productivity is improved.

When the concentration of silver ions in the reaction solution is 2.5 mol/L or lower, an increase in the viscosity of the reaction solution is suppressed and an excellent stirring property is obtained.

### <Optional Component>

If necessary, the reaction solution may contain one type or two or more types of optional components other than the aforementioned components.

### <Complex Compound>

In the reaction solution containing carboxylic acid silver, an aliphatic carboxylic acid (preferably a long-chain carboxylic acid), and a medium, one type or two or more types of complex compounds (aliphatic carboxylic acid silver complexes) derived from the carboxylic acid silver are generated.

The structure of the complex compound is not limited to any particular structure. Further, the structure of the complex compound in the reaction solution may change as the reaction advances.

The complex compound can contain silver ions, and an aliphatic carboxylic acid or its ions, which acts as a ligand.

When an amino alcohol is used as a complexing agent, the complex compound may contain silver ions, an aliphatic carboxylic acid or its ions, and an amino alcohol, which acts as a ligand.

When the complex compound contains an amino alcohol as a ligand, the thermal decomposition temperature of the complex compound tends to decrease.

It is considered that in the complex compound, carboxylic acid ions derived from carboxylic acid silver are ionically bonded to silver ions.

Note that various aspects are conceivable as to the type of the ligand and the number thereof in the complex compound.

The complex compound generated in the reaction solution can produce silver core particles through a thermal decomposition process. The temperature of the thermal decomposition process is appropriately selected according to the structure of the complex compound and the like.

In general, the thermal decomposition temperature of carboxylic acid silver tends to decrease as the carboxylic acid silver forms a complex compound with the amino alcohol.

For example, the thermal decomposition temperature of silver oxalate is considered to be about 210 to 250° C. However, as the silver oxalate forms a complex compound with the amino alcohol, the thermal decomposition temperature of the silver oxalate can be lowered to about 70 to 120° C.

Therefore, the heating temperature of the reaction solution in which an amino alcohol is used as a complexing agent (i.e., the thermal decomposition process temperature) is preferably 60 to 130° C. and more preferably 80 to 130° C.

As silver core particles are generated through the thermal decomposition process of the complex compound and the aliphatic carboxylic acid is absorbed onto the surfaces of the generated silver core particles (physical adsorption, ion adsorption, etc.), coated silver particles in which each of silver core particles is coated with a plurality of aliphatic carboxylic acid molecules can be obtained.

The duration of the thermal decomposition process can be appropriately selected according to the temperature of the thermal decomposition process. For example, the duration of the thermal decomposition process is preferably 30 to 180 minutes.

The atmosphere of the thermal decomposition process is not limited to any particular atmosphere, and may be an air atmosphere or an inert atmosphere such as a nitrogen atmosphere.

In the manufacturing method for coated silver particles, the grain-size distribution of coated silver particles can be adjusted to a narrow range by adjusting the amount and the type of the added aliphatic carboxylic acid, the concentration of the carboxylic acid silver complex, the ratio of the mixed media (primary medium/auxiliary medium), and so on.

The sizes of coated silver particles can be uniformed by appropriately maintaining the temperature rising rate, which influences the number of generated metal cores, i.e., appropriately maintaining the amount of the heat input to the reaction system and the stirring speed, which is significantly related to the size of the micro reaction field.

In the manufacturing method for coated silver particles, coated silver particles having a narrow grain-size distribution are obtained. The conceivable reason for this narrow distribution is, for example, as follows.

The ΔSP value, which is a difference between the SP value of the amino alcohol used as a complexing agent for making carboxylic acid silver soluble to the reaction medium and the SP value of the medium, is preferably 4.2 or higher. In this case, the complex compound generated in the reaction solution can be dissolved in the reaction solution. However, when the complex compound is thermally decomposed and the amino alcohol, which is the complexing agent, is liberated therefrom, the liberated amino alcohol, which is not compatible with the medium, starts to form two phases.

The liberated amino alcohol has high affinity for the carboxylic acid silver and the complex compound, and can act as a new complexing agent for carboxylic acid silver or as a new medium. As a result, the liberated amino alcohol forms inner cores (droplets) having a high polarity. Further, as the medium having a low polarity surrounds outsides of the inner cores and hence a two-phase structure similar to Water-in-oil Emulsion is formed. It is presumed that this two-phase structure functions as a micro reaction field.

Water in the reaction system and a carboxylic acid desorbed by replacement by the aliphatic carboxylic acid are also present in the above-described micro reaction field.

It is considered that in the micro reaction field, metal cores and particles grown therefrom, a carboxylic acid silver amino alcohol complex, water, and a carboxylic acid are liberated from the medium into the amino alcohol layer, and thereby the reaction advances.

If necessary, the manufacturing method for coated silver particles may further include, after the step of the thermal decomposition process, a step of washing coated silver particles, a separation step, a drying step, and so on.

Publicly-known methods can be applied to these subsequent steps.

The washing step can be carried out by using, for example, an organic medium.

The organic medium used in the washing step is not limited to any particular medium, and Examples thereof include an alcoholic medium such as methanol, a ketone medium such as acetone, etc. One type or two or more types of these media can be used.

### [Conductor]

A conductor according to the present invention is a thermally-processed product of the above-described conductive composition according to the present invention.

The conductor is not limited to any particular conductor, and examples thereof include wiring lines, a conductor layer, etc.

Examples of the conductor layer include an electrode layer, a bonding layer, etc.

Examples of the bonding layer include a bonding layer for bonding a substrate and a semiconductor device such as an IC (Integrated Circuit) chip.

The thickness of the conductor according to the present invention is not limited to any particular value, and is preferably, for example, about 1 to 100 μm.

A conductor according to the present invention can be manufactured by a manufacturing method including a step of applying a conductive composition according to the present invention to a substrate, and a step of sintering the applied conductive composition.

The substrate includes at least a substrate main body. Further, if necessary, the substrate may include a layer formed on the substrate main body, and one type or two or more types of elements such as components.

Examples of the substrate main body include:

a resin such as polyimide;

glass;

ceramic such as silica and alumina;

a metal such as stainless steel, copper, and titanium; and

a semiconductor such as silicon.

The substrate main body may be made of a composite material.

For uses in semiconductor components, electronic devices, etc., a lead frame, a substrate, and the like are preferably used as the substrate main body. The thickness of the substrate is preferably, for example, about 0.01 to 5 mm.

The coating method is not limited to any particular method. Publicly-known printing methods such as an ink-jet printing method, a screen printing method, a flexographic printing method, a dispensing printing method, etc. can be adopted.

A conductive composition according to the present invention can be printed into a desired pattern by the aforementioned printing method.

The sintering temperature of the conductive composition is not limited to any temperature. The sintering temperature is, for example, 100 to 600° C., and is preferably 150 to 350° C.

The sintering time is selected according to the sintering temperature. The sintering time is, for example, 1 to 120 minutes, and is preferably 1 to 60 minutes.

In the sintering step, pressure sintering may be performed as required.

The pressing force is not limited to any particular value, and is preferably 0.1 to 100 MPa and more preferably 0.1 to 50 MPa.

The sintering atmosphere is not limited to any particular atmosphere, and may be an air atmosphere or an inert atmosphere having a low oxygen concentration. Examples of the inert atmosphere having a low oxygen concentration include an inert gas atmosphere such as a nitrogen atmosphere and an argon atmosphere, a reduced-pressure atmosphere, etc.

### EXAMPLES

Examples of production and examples of embodiments according to the present invention, and comparative examples are described hereinafter.

### [Production Example 1] “Production of Silver Oxalate”

A three-necked glass flask having a volume of 1,000 mL and equipped with a stirrer, a thermometer, and a reflux condenser was placed in an oil bath. Then, 73 g of an oxalic acid (manufactured by Kanto Chemical Co., Inc.) and 200 g of ion-exchanged water were put in this flask, and the contents were stirred and mixed. A silver nitrate aqueous solution obtained by dissolving 200 g of silver nitrate (manufactured by Kanto Chemical Co., Inc.) into 200 g of ion-exchanged water was dropped little by little into this mixture solution while uniformly stirring the contents in the flask. The reaction solution was heated to 40° C. by using the oil bath while stirring and mixing the reaction solution, and the heating and the stirring were continued at this reaction temperature. Immediately after the start of the reaction, white crystals started to precipitate. After three hours from the end of the dropping, the reaction was terminated and the reaction solution was naturally cooled to a room temperature. The obtained precipitate was filtered and washed with 1,000 mL of ion-exchanged water. The obtained filtrate was a white solid. Lastly, the filtrate was dried under a reduced pressure (vacuum drying) at a temperature of 40° C. or lower and a pressure of 3 kPa or lower. As a result, 167 g of white silver oxalate was obtained.

For the obtained silver oxalate, its crystal structure was identified by a PXRD analysis, and disappearance of the ingredient and formation of a target substance were confirmed.

### [Example 1-1] “Production of Coated Silver Particles (AgP1)”

A three-necked glass flask having a volume of 300 mL and equipped with a stirrer, a thermometer, and a reflux condenser was placed in an oil bath.

Then, 30 g of silver oxalate obtained in Production Example 1,

4 g of a lauric acid (manufactured by Tokyo Chemical Industry Co., Ltd.),

10 g of tripropylene glycol monomethyl ether (manufactured by Tokyo Chemical Industry Co., Boiling point: 242° C., SP value: 9.20) used as a medium (an auxiliary medium), and

54 g of a petroleum hydrocarbon (a C9 alkyl cyclohexane mixture) (“SWACLEAN 150” manufactured by Godo Co., Ltd. (Boiling point: 149° C., SP value: 7.99) used as a medium (a primary medium) were put in the aforementioned flask, and

the contents were stirred and mixed.

The reaction solution was heated to 40° C. by using the oil bath while stirring and mixing the reaction solution. Then, 53 g of 3-amino-1-propanol (manufactured by Tokyo Chemical Industry Co., Ltd.) used as a complexing agent was slowly dropped into the reaction solution while continuing the heating and the stirring at the reaction temperature. After the dropping was finished, the solution was heated at a temperature rising rate of about 1° C./min until the temperature of the solution reached about 85° C. Further, the heating and the stirring were continued at this temperature. After three hours from the end of the dropping, the heating of the oil bath was stopped and hence the reaction was terminated. Then, the reaction solution was naturally cooled to a room temperature.

Then, 200 mL of methanol (manufactured by Kanto Chemical Co., Inc.) was added in the reaction solution, which had been cooled to the room temperature, and the contents were mixed. After leaving the mixture solution undisturbed for 30 minutes or longer, a supernatant liquid was decanted and a precipitate was obtained.

Then, 100 mL of methanol (manufactured by Kanto Chemical Co., Inc.) and 100 mL of acetone (manufactured by Kanto Chemical Co., Inc.) were added in the aforementioned precipitate, and they were mixed. After leaving the mixture solution undisturbed for 30 minutes or longer, a supernatant liquid was decanted and a precipitate was obtained. The above-described operations (the addition of methanol and acetone, and the decantation) were repeated one more time.

Then, 200 mL of methanol (manufactured by Kanto Chemical Co., Inc.) was added in the aforementioned precipitate, and they were mixed. After leaving the mixture solution undisturbed for 30 minutes or longer, a supernatant liquid was decanted and a precipitate was obtained.

Then, 100 mL of methanol (manufactured by Kanto Chemical Co., Inc.) and 1.7 g of isobutyric acid 3-hydroxy-2,2,4-trimethylpentyl was added to the obtained precipitate, and they were mixed. This mixture was put in a recovery flask and placed in a rotary evaporator. Then, the contents were dried under a reduced pressure (vacuum drying) at a temperature of 40° C. and a pressure of 1 kPa or lower. After the drying under the reduced pressure (vacuum drying), the contents were naturally cooled to a room temperature. Then, the pressure inside the recovery flask was restored from the reduced state while replacing the gas inside the flask with nitrogen.

Through the above-described processes, 18 g of violet coated silver particles (AgP1) were obtained.

### [Example 1-2] “Production of Coated Silver Particles (AgP2)”

In this example, 18 g of violet coated silver particles (AgP2) were obtained through processes similar to those of Example 1-1, except that the reaction temperature (the heating temperature after the addition of 3-amino-1-propanol) was 100° C.

### [Evaluation]

The coated silver particles (AgP1) and (AgP2) obtained in Examples 1-1 and 1-2 were evaluated as described below.

### (Powder X-Ray Diffraction Analysis (PXRD Analysis))

Crystal structures were identified by PXRD analyses, and disappearances of ingredients and peaks resulting from silver were confirmed.

### (Gas Chromatography Mass Spectrometry (GC-MS Analysis))

Organic coatings were identified by GC-MS analyses, and it was confirmed that they were lauric acids.

### (Thermogravimetric/Differential Thermal Analysis (TG-DTA Analysis))

TG-DTA analyses were carried out and amounts of organic coatings were measured. A weight reduction ratio in a range from about 180° C. to 350° C. (near the boiling point of a lauric acid) corresponds to an amount of evaporation of the coating layer (an amount of an organic coating). The amounts of the organic coatings were in a range of 1.0 to 1.3 mass %.

The amount of the organic coating of coated silver particles (AgP1) of Example 1-1 was 1.2 mass %.

The amount of the organic coating of coated silver particles (AgP2) of Example 1-2 was 1.3 mass %.

Based on the results of the TG-DTA measurement, it was suggested that lauric acids were physically adsorbed in Examples 1-1 and 1-2.

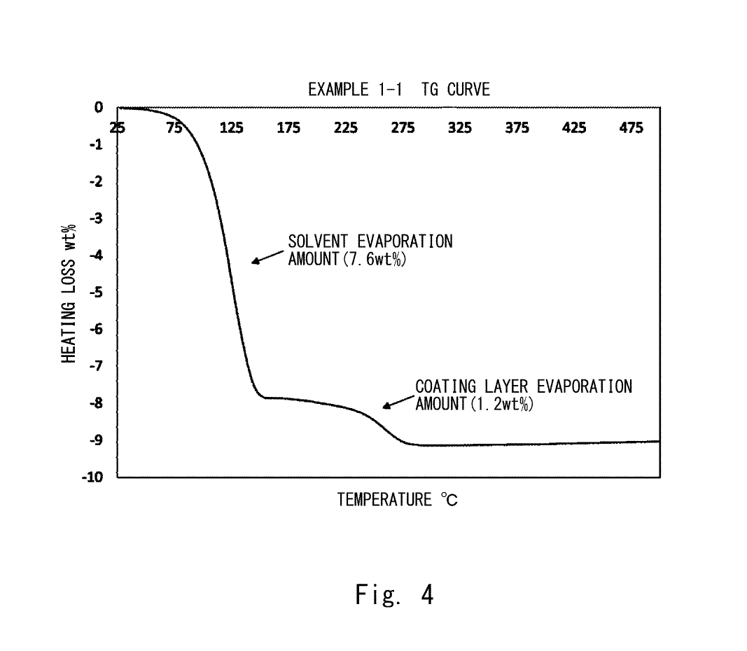

As a representative example, FIG. 4 shows a TG curve of coated silver particle (AgP1) of Example 1-1.

### (Measurement of Coating Density of Aliphatic Carboxylic Acid)

Coating densities of aliphatic carboxylic acids (lauric acids in this example) covering surfaces of silver core particles were obtained by the method described in the “Solution to Problem” section. The coating densities were in a range of 2.5 to 5.2 molecules/nm².

A coating density of coated silver particles of Example 1-1 (AgP1) was 5.1 molecules/nm².

A coating density of coated silver particles of Example 1-2 (AgP2) was 4.1 molecules/nm².

In “Chemistry and Education, Vol. 40, No. 2 (1992), Determining cross-sectional area of stearic acid molecule, —Experimental values and Calculated values—”, a minimum area is calculated from the Van der waals radius of stearic acid molecules, and a theoretical value of a saturated coating area determined from this calculated value is about 5.00 molecules/nm². From this theoretical value, it was inferred that in the coated silver particles (AgP1) and (AgP2), a lauric acid was absorbed to surfaces of silver core particles at a relatively high density.

### (SEM Observation)

SEM observations were carried out, and particle shapes, average primary particle diameters D_{SEM}, and particle-diameter variation rates were evaluated.

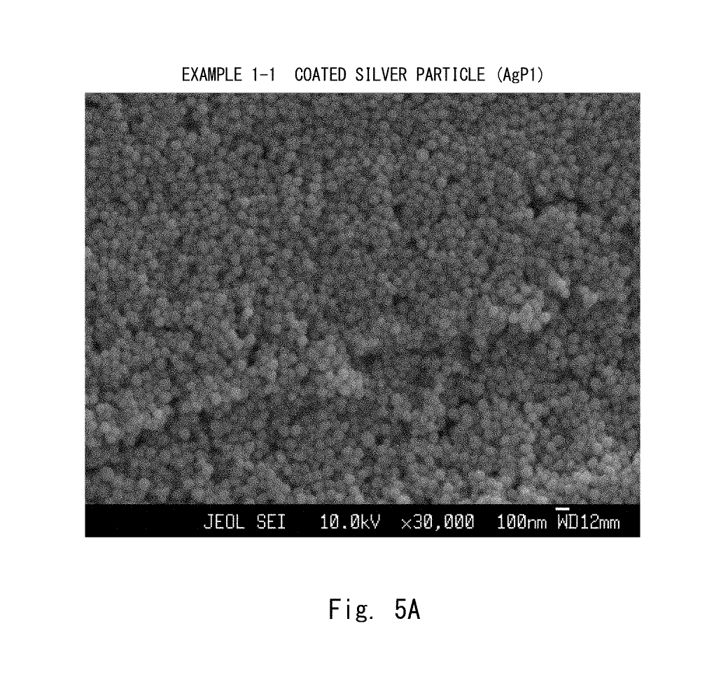

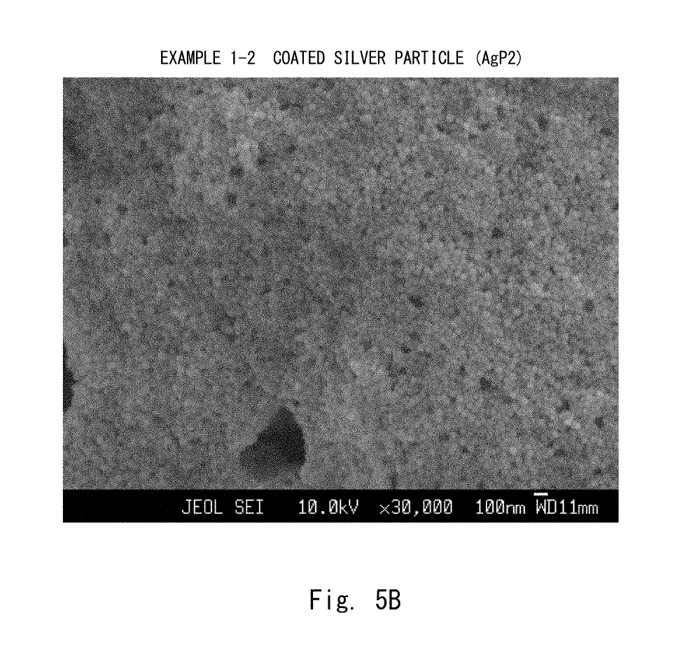

FIGS. 5A and 5B show SEM photographs of coated silver particles (AgP1) and (AgP2).

The particle shapes were spherical, and the average primary particle diameters D_{SEM} were in a range of 0.02 to 5.0 μm.

The average primary particle diameter of the coated silver particles (AgP1) of Example 1-1 was 81.5 nm.

The average primary particle diameter of the coated silver particles (AgP2) of Example 1-2 was 58.1 nm.

The particle-diameter variation rates were in a range of 0.01 to 0.5. That is, coated silver particles having uniform particle diameters were obtained in Examples 1-1 and 1-2.

### [Example 2] “Manufacturing of Conductive Composition”

A conductive composition (a pasty conductive composition) was produced by using coated silver particles (AgP1) obtained in Example 1-1.

As a first metal powder having a relatively large average particle diameter, a silver powder having an average particle diameter of 3.6 μm (“SPN30J” manufactured by Mitsui Mining & Smelting Co., Ltd.) was prepared.

As a second metal powder having a relatively small average particle diameter, a silver powder having an average particle diameter of 1.3 μm (“SPN05S” manufactured by Mitsui Mining & Smelting Co., Ltd.) was prepared.

As a dispersant, a polyacrylic-acid-based dispersant (“Malialim” manufactured by NOF Corporation) was prepared.

As a thickener, a polymethacrylic-acid-based thickener (“KC1100” manufactured by NOF Corporation) was prepared.

As a medium, 2,2,4-trimethyl-1,3-pentanediol monoisobutyrate (“Kyowanol M” manufactured by NH Neochem Co., Ltd.) was prepared.

Coated silver particles (AgP1) obtained in Example 1-1, the aforementioned first and second metal powders, the aforementioned dispersant, the aforementioned thickener, and the aforementioned medium were mixed in the below-shown composition. They were dispersed, mixed, and kneaded by using an automatic grinding device and a conductive composition was obtained.

### <Mixing Formula>

Coated silver particles (AgP1): 40 pts·mass,
First metal powder: 40 pts·mass,
Second metal powder: 10 pts·mass,
Dispersant: 0.4 pts·mass,
Thickener: 0.1 pts·mass, and
Medium: 5 pts·mass.

### [Example 3] “Formation of Bonding Layer”

As a base material, a copper lead frame with silver plating formed on its surface (a silver-plated lead frame) was prepared.

By a screen printing method using a mask, a conductive composition obtained in Example 2 was applied to a chip mounting part of the aforementioned lead frame (having a square shape 9 mm on each side in a plan view) so that a coating of the conductive composition having a thickness of 50 μm was formed in a square shape 9 mm on each side.

Separately, an IC (Integrated Circuit) chip in which a silicon wafer was used as a substrate and silver plating was formed as a barrier layer on its surface was prepared.

Chip bonding was carried out by using a chip bonding device equipped with a hot stage, and a bonding head that is disposed so as to be opposed to the hot stage, and configured to suck and hold the IC chip.

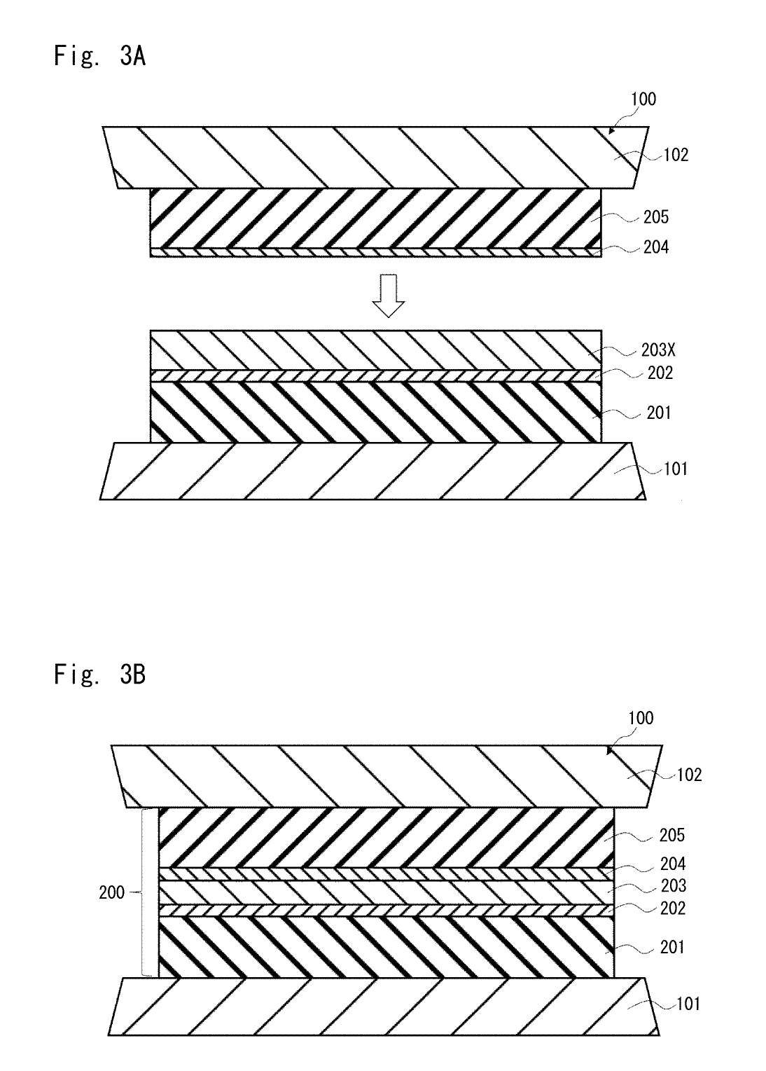

As shown in FIG. 3A, the above-described silver-plated lead frame coated with the pasty silver composition was placed on the hot stage in a state in which the hot stage and the bonding head are sufficiently spaced apart from each other. Then, the aforementioned silver-plated IC chip was sucked and held on the lower surface of the bonding head.

Next, as shown in FIG. 3B, the bonding head was lowered, and a coating film of the pasty silver composition was pressurized and sintered. As a result, a silver bonding layer (a conductive layer for bonding) was formed.

Conditions for the pressurizing and sintering were as follows.

Sintering temperature: 300° C.,
Pressing force: 30 MPa, and
Heating and pressing time: 10 minutes.

In the above-described manner, a laminated product composed of an IC chip/a barrier layer (a silver plating layer)/a silver bonding layer/a silver plating layer/a lead frame was obtained.

FIGS. 3A and 3B are schematic cross sections.

Reference numbers in the figures indicate the following components.
100: Chip bonding device,
101: Hot stage,
102: Bonding head,
201: Lead frame,
202: Silver plating layer,
203X: Coating film,
203: Silver bonding layer,
204: Barrier layer (silver plating layer),
205: IC chip, and
200: Laminated product.

A SEM cross-sectional observation was carried out for the obtained laminated product, and it was observed that the silver bonding layer of the obtained laminated product was a fine and uniform conductive layer.

### [Example 4] “Formation of Conductor Layer”

A conductive composition obtained in Example 2 was applied to a polyimide film having a thickness of 40 μm, with a copper foil having a thickness of 12 μm being laminated on its rear surface, so that a coating of the conductive composition having a thickness of 10 μm was formed in a square shape 9 mm on each side.

Next, the coated film was heated for 1 hour at 350° C. and a conductor layer was obtained.

A volume resistivity value of the obtained conductor layer was measured, and it was 5 μ∩∩cm. That is, it was found that the obtained conductor layer had a conductivity comparable to that of an Ag bulk body.

The present invention is not limited to the above-described embodiments and examples, and various design modifications can be made as appropriate without departing from the spirit and scope of the present invention.

This application is based upon and claims the benefit of priority from Japanese patent application No. 2016-064296, filed on Mar. 28, 2016, the disclosure of which is incorporated herein in its entirety by reference.

### REFERENCE SIGNS LIST

1: CONDUCTIVE COMPOSITION
10: METAL POWDER
11: FIRST METAL POWDER
12: SECOND METAL POWDER
20: COATED SILVER PARTICLE
21: SILVER CORE PARTICLE
22: ALIPHATIC CARBOXYLIC ACID MOLECULE
100: CHIP BONDING DEVICE
101: HOT STAGE
102: BONDING HEAD
201: LEAD FRAME
202: SILVER PLATING LAYER
203X: COATING FILM
203: SILVER BONDING LAYER (CONDUCTIVE LAYER)
204: BARRIER LAYER (SILVER-PLATING LAYER)
205: IC CHIP
200: LAMINATE

1. A coated silver particle containing a silver core particle, and a plurality of aliphatic carboxylic acid molecules disposed on a surface of the silver core particle at a density of 2.5 to 5.2 molecules per square nanometer (nm²).

2. The coated silver particle according to claim 1, wherein a carbon number of an aliphatic group of the aliphatic carboxylic acid molecule is 5 to 26.

3. The coated silver particle according to claim 1, wherein when an arithmetical average value and a standard deviation of primary particle diameters are represented by D_{SEM} and SD, respectively,
D_{SEM} is 0.02 to 5.0 μm and a particle-diameter variation rate defined by a general formula SD/D_{SEM} is 0.01 to 0.5, the primary particle diameters being obtained by observing 20 arbitrarily-selected particles by a scanning electron microscope.

4. A manufacturing method for coated silver particles comprising a step (A) of thermally decomposing an aliphatic carboxylic acid silver complex in a medium.

5. The manufacturing method for coated silver particles according to claim 4, wherein the step (A) comprises:
a step (A1) of preparing a reaction solution containing silver carboxylate, an aliphatic carboxylic acid, and a medium; and
a step (A2) of thermally decomposing a complex compound formed in the reaction solution and thereby generating metallic silver.

6. The manufacturing method for coated silver particles according to claim 5, wherein the reaction solution further contains a complexing agent.

7. The manufacturing method for coated silver particles according to claim 6, wherein the complexing agent is an amino alcohol.

8. The manufacturing method for coated silver particles according to claim 5, wherein a thermal decomposition temperature of the silver carboxylate is 100° C. or higher.

9. A conductive composition containing a coated silver particle according to claim 1, and a medium.

10. A conductor, which is a heat-treated product of the conductive composition according to claim 9.

11. The coated silver particle according to claim 2, wherein when an arithmetical average value and a standard deviation of primary particle diameters are represented by D_{SEM} and SD, respectively,
D_{SEM} is 0.02 to 5.0 μm and a particle-diameter variation rate defined by a general formula SD/D_{SEM} is 0.01 to 0.5, the primary particle diameters being obtained by observing 20 arbitrarily-selected particles by a scanning electron microscope.

12. A conductive composition containing a coated silver particle according to claim 2, and a medium.

13. A conductive composition containing a coated silver particle according to claim 3, and a medium.

14. A conductive composition containing a coated silver particle according to claim 11, and a medium.

15. A conductor, which is a heat-treated product of the conductive composition according to claim 12.

16. A conductor, which is a heat-treated product of the conductive composition according to claim 13.

17. A conductor, which is a heat-treated product of the conductive composition according to claim 14.

18. The manufacturing method for coated silver particles according to claim 6, wherein a thermal decomposition temperature of the silver carboxylate is 100° C. or higher.

19. The manufacturing method for coated silver particles according to claim 7, wherein a thermal decomposition temperature of the silver carboxylate is 100° C. or higher.
